(19) United States
(12) Patent Application Publication
(10) Pub. No.: US 2010/0303583 A1
(43) Pub. Date: Dec. 2, 2010

(54) NAIL FOR USE IN DRY CONSTRUCTION

(75) Inventors: Stefan Siemers, Burghausen (DE); Christian Lindlbauer, Rossbach (AT)

Correspondence Address: MICHAEL BEST & FRIEDRICH LLP, 100 E WISCONSIN AVENUE, Suite 3300, MILWAUKEE, WI, 53202, US

(73) Assignee: RAIMUND BECK NAGELTECHNIK GMBH, Mauerkirchen (AT)

(21) Appl. No.: 12/473,779

(22) Filed: May 28, 2009

(51) Int. Cl. F16B 15/08; F16B 15/00; B21G 3/00

(52) U.S. Cl. 411/442; 411/439; 470/34

(57) ABSTRACT

An attachment means, in particular a nail for use in dry construction, which is made in one piece from a plane raw material by punching and/or cutting and bending, having a shaft on one end region of which a point and on the other end region of which a head bent substantially perpendicularly to the two-dimensional extension of the shaft are formed, wherein sections of the head project over the shaft to both sides of a bend line formed upon bending the head.

### SUMMARY

The present invention relates to an attachment means, in particular to a nail for use in dry construction, which is made in one piece from a plane raw material by punching and/or cutting and bending, having a shaft on one end region of which a point and on the other end region of which a head is formed, bent substantially perpendicularly to the plane extension of the shaft. Furthermore the invention relates to a strip of nails with a number of attachment means according to the invention connected to one another by means of attachment bars, and a method of producing an attachment means according to the invention and a strip of nails according to the invention.

Attachment elements and strips of nails of the type specified above are already known and described, for example, in document DE 30 02 321 A1. The document shows a nail and a strip of nails comprising a number of nails which are connected to one another by connection bars both produced from a thin metal sheet by punching and bending. For production the nail is first of all punched out of a thin metal sheet and one of the ends of the nail is simultaneously or subsequently bent to the side in order to form a nail head aligned to the side.

In comparison to nails produced conventionally from a drawn or rolled wire, the advantage of this nail is that a smaller quantity of material is required in order to provide the required nail surface, and so both the weight of the nail and material costs are reduced, but the nail type is only suitable to a limited degree for use in a nail placement appliance.

This is due to the fact that because of the sideways alignment of the nail head there is the risk that the nail will tilt in the nail placement appliance because a torque acting on the nail when the nail head is impacted is relatively large. Another disadvantage of the sideways alignment of the nail head is that it is not possible to apply a necessary force in order to place the nail such that the direction of force of the latter corresponds almost totally to the longitudinal extension of the nail shaft. Consequently, one can only make insufficient allowance for bending moments, in particular when impacting the end of the nail head facing away from the nail shaft.

Furthermore, the consequence of this is that in order to insert the nail into the component being assembled, a greater overall force must be applied to the nail head in comparison to conventional nails, and the nail or the screw is to be appropriately designed as regards strength.

It is therefore an object of the present invention to provide an attachment means which can be produced simply and inexpensively with as few procedural steps as possible, and at the same time enables homogeneous application of the placement force to the shaft so that the attachment means is then also suitable for use in nail placement appliances.

This object is achieved according to the invention in that sections of the head project over the shaft to both sides of a bend line formed upon bending the head.

In other words, by means of the design of the head according to the invention and an extension of the head to both sides of the two-dimensional extension of the shaft, the occurrence of bending moments is reduced or even totally prevented depending on the form of the sections because the direction of force resulting from the placement force can be made to correspond substantially to the alignment of the shaft.

The head can be designed such that it projects over the shaft to both sides of the two-dimensional extension of the shaft as well as transversely to the latter.

If the head has a substantially circular cross-sectional surface which is positioned centrically in relation to the shaft, bending moments can even be totally eliminated when applying the placement force to the nail head, and this leads to even insertion of the nail into the component being assembled and furthermore enables the force chosen to apply the head of the attachment means to be as small as required. The advantage of this is that the dimensions of the attachment means can likewise be correspondingly reduced because when placing the nail it is subjected to smaller forces, and this automatically leads to a reduction in the material costs and in the weight.

In order to be able to implement corresponding centric positioning of the head in relation to the shaft, cuts are provided on the head, in particular in the extension of the shaft, between the end regions of which a bend line formed between the head and the shaft extends.

With this type of design it is made possible, by means of a simple, one-step bending process, to provide an attachment means with a head positioned centrically in relation to the shaft. Since just a single bend line need to be made in the plane raw material in order to produce an attachment means according to the invention, production is also particularly easy to implement in a one-stage process step.

It is therefore possible, by means of a single bend process, i.e. in accordance with the invention, by means of a bend about a single bend point or a single bend line without reversing the bend direction, to align the head perpendicular to the shaft and thereby provide the head with any cross-sectional surface. Of course it is possible to provide an end region at at least one section of the head with a further bend line about which the end region is bent relative to the head. The end sections can be bent here without changing the bend direction such that they penetrate into the surface of the component when inserted into the component being assembled and can thus form a further anti-twist protection of the attachment means in the component.

In order to vary the embodiment of the cross-sectional surface of the head it is only necessary to design the punching tool in accordance with the desired outer contour. Thus, all possible geometric cross-sectional surfaces, such as for example substantially rectangular, circular or conical cross-sectional surfaces, or also cross-sectional surfaces in the shape of animals or stars or hearts for decorative purposes, can be produced.

The attachment means has a notch in the head the dimensions of which are defined by the bend line and the formation of the cuts. Here, the contour of the notch can substantially correspond to the outer contour of at least one section of the shaft in the region beneath the head.

In one exemplary embodiment the cuts, and so the form of the notch, in the head are chosen such that the shaft and the point are made entirely of the material bent from the attachment head.

Of course it is also possible to choose the cuts such that the outer contour of the shaft differs from the shape of the notch.

In one exemplary embodiment of the present invention the punching and cutting line of the punching and cutting tool is chosen such that the head is designed with a slant in order to avoid any damage to a component surface facing towards the head and to be equipped with the attachment means. This type of slant can be achieved by appropriately choosing the punching and cutting guide. In this way a paper surface provided, for example, with gypsum plasterboards is prevented from being torn or ripped when inserting the attachment means in the region of the head lying over the latter.

In a further exemplary embodiment of the present invention projections, in particular teeth, are provided on the attachment means in the region of the shaft in order to increase the extraction values of the attachment means.

The attachment means can be a nail or a screw or a combination of the latter—a so-called screw nail. It can be made of simple construction steel, of spring steel or also of a synthetic material. Other types of steel are also possible. The material can also be subjected to heat treatment.

In order to support any desired resilient property of the attachment means, in a further exemplary embodiment the shaft can be slotted in design or can be provided with a bore. With this type of exemplary embodiment the principle of the attachment means in its slotted form is based upon the principle of a locking pin according to DIN 1481. In this case the attachment means has an excessive diameter in relation to the hole made in the component. When driving in the attachment means the shaft is compressed by means of which its diameter is initially adapted to the hole. The reset force of the shaft produces a press fit between the shaft and the walls of the hole in the component to be assembled, and this further increases the extraction values of the attachment means.

In a further exemplary embodiment the point of the attachment means is not ground. This means that material from the components to be connected displaced by the point, such as for example plasterboard with a block construction in dry construction, is not punched out as is normal in the prior art. Instead, the material is cut out, the separated metal sheet abutting the shaft to the side, and so serving the attachment means as an additional hold, and so further improving the extraction values because the sheet metal lies resiliently against the indents in the attachment means. Furthermore, no cut out waste contaminating the area surrounding the component and which needs to be disposed of is produced.

Due to the simple structure of the attachment means according to the invention it is also possible to produce a strip of nails according to the invention for a nail placement appliance which is formed in one piece from a plane raw material by punching and/or cutting and bending from a number of attachment means according to the invention connected to one another by means of at least one separable bar, produced from steel in a one-step production process.

In order to produce an attachment means according to the invention, in particular a nail with a shaft on one end region of which a point and on the other end region of which a head bent substantially perpendicularly to the two-dimensional extension of the shaft are formed, the attachment means being made in one piece from a plane raw material, it is proposed according to the invention to punch/cut an outer contour of the attachment means from the plane raw material, to make cuts in the attachment means, in particular in the extension of the outer contour of the shaft, and to bend the attachment means in the region of the cuts after or while making the cuts such that the head extends substantially perpendicularly to the shaft so that sections of the head project over the shaft to both sides of a bend line formed between end regions of the cuts upon bending the head. The head may also extend transversely to the latter.

One advantageous embodiment of the method according to the invention makes provision such that the cuts are made so that the head extends centrically to the shaft after bending. This can be achieved, for example, by the cuts being made parallel to the side surfaces of the shaft in the region of the head and thus extending from the outer surface to a plane formed by the two-dimensional extension of the shaft.

Of course it is also possible to produce a whole strip of nails with a number of nails according to the invention in a one-step process by a number of attachment means connected to one another by bars and the connecting bars being punched/cut out of the plane material at the same time, cuts being made in the attachment means in particular in the extension with the outer contour of the respective shafts and the attachment means in the region of the cuts being bent after or while making the cuts such that the heads respectively extend substantially perpendicularly to the shafts, sections of the heads respectively projecting over the shafts to both sides of a bend line formed by bending the ends between end regions of the cuts.

It is also possible here to make the cuts by means of appropriate cut guiding such that the heads respectively extend centrically to the shafts after bending.

With regard to further advantageous embodiments of the present invention reference is made to the sub-claims and to the explanations given in the following description of the figures.

### BRIEF DESCRIPTION OF THE DRAWINGS

FIG. 1 is a perspective view of an attachment means according to the invention;

FIG. 2 is a top view of the attachment means according to the invention of FIG. 1;

FIG. 3 illustrates an attachment means according to FIGS. 1 and 2 inserted into a profile commonly used with dry construction;

FIG. 4 is a perspective view of a strip of nails according to the invention;

FIG. 5 is a schematic illustration of the technical production sequence for shaping the head of an attachment means according to the invention according to FIGS. 1 and 2; and

FIG. 6 is a schematic illustration of the production of a strip of nails according to the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

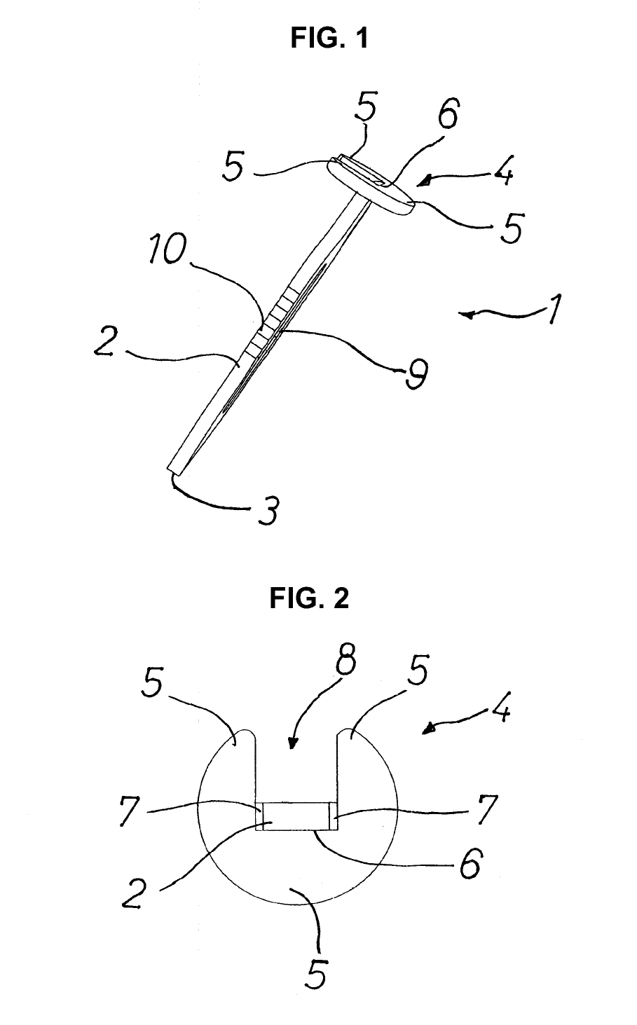

FIG. 1 shows an attachment means 1 according to the invention, here in the form of a nail, for use in dry construction.

The nail 1 is made in one piece from a plane raw material by punching or cutting and bending. It has a shaft 2 on one end region of which a point 3 and on the other end region of which a head 4 bent substantially perpendicularly to the two-dimensional extension of the shaft 2 are formed. The head 4 has sections 5 which project over the shaft 2 to both sides of a bend line 6 formed upon bending the head 4 as well as transversely to the latter.

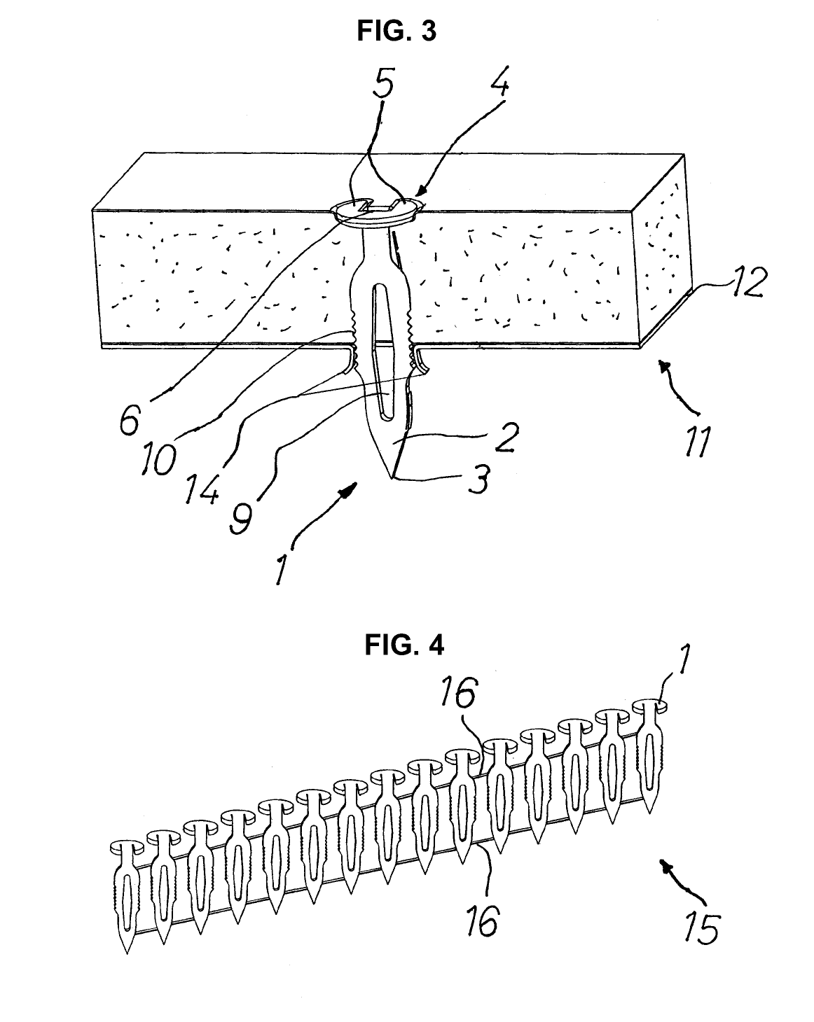

As can be seen in more detail in FIG. 2, the head 4 has a substantially circular cross-sectional surface which is aligned centrically to the shaft 2. By means of the centric positioning of the head 4 above the shaft 2, when a force is applied in order to drive the attachment means 1 into a component, bending moments are prevented from occurring because the direction of force resulting from the placing force is made to correspond to the alignment of the shaft 2 by the centric positioning of the head 4 and the force portions applied a distance away from the central positioning of the shaft lift one another reciprocally to both sides of the bend line 6. In order to be able to implement corresponding centric positioning of the head 4 in relation to the shaft 2, cuts 7 are provided in the head 4, in particular in the extension of the shaft 2, between the end regions of which the bend line 6 formed between the head 4 and the shaft 2 extend.

After bending the head 4, the part of the head 4 separated from the head 4 by the cuts 7 forms the part of the shaft 2 directly beneath the head 4. Therefore, by choosing the sequence of cuts 7, the outer contour of the part of the shaft 2 disposed beneath the head 4 or also the contour of the sections 5 can be variable in form.

In this exemplary embodiment the attachment means 1 has a notch 8 in the head 4 after bending the head 4 the dimensions of which are defined by the bend line 6 and the form of the cuts 7. The contour of the notch 8 consequently corresponds to the outer contour of the shaft 2 in the region beneath the head 4.

The attachment means 1 is produced from steel, in particular from a construction steel. In this exemplary embodiment the shaft 2 is slotted in design and has a corresponding opening 9. Furthermore, projections 10 are formed on the shaft 2 in the form of teeth in order to increase the extraction values of the attachment means 1.

FIG. 3 shows an attachment means 1 according to the invention which is inserted into a profile conventional for dry construction, here in the form of a gypsum plasterboard 11 attached to a metal sheet 12. When producing the attachment means 1 the punching or cutting line of the punching or cutting tool was chosen such that in order to prevent damage to the paper surface provided with gypsum plasterboards 11 the head 4 separates or rips when applying the attachment means 1 in the region of the head 4 lying over it and instead the paper surface is drawn in beneath the head 4.

In this exemplary embodiment the attachment means 1 is designed such that it is based upon the principle of a locking pin according to DIN 1481. The diameter of the attachment means 1 is chosen here such that it is excessive in relation to the hole made in the component in the front end. Upon driving in the attachment means 1 the shaft 2 is compressed by means of which its diameter is first of all adapted to the hole in the gypsum plasterboard 11. By means of the reset force of the shaft 2 a press fit is then established between the shaft 2 and the walls of the hole in the gypsum plasterboard 11 by means of which the extraction values of the attachment means 1 are increased.

In this exemplary embodiment the point 3 is not ground so that gypsum plasterboard 11 and sheet metal 12 material displaced by the point 3 is not punched out, as is normal in the prior art, but the metal sheet 12 is cut by the point 3 such that the cut part of the metal sheet 12 is bent to the side, and the bent sections 14 abut the shaft 2. Since the metal sheet 12, as illustrated here, resiliently abuts the teeth 10 of the attachment means 1, in this way the extraction values of the attachment means 1 are further increased.

Due to the simple structure of the attachment means 1 according to the invention it is also possible to also fully produce a strip of nails 15 in a simple, one-step production process which is used with a nail placement appliance because it is made in one piece from a plane raw material by punching and/or cutting and bending from a number of attachment means 1 connected to one another by means of separable bars 16. As shown by FIG. 4, a corresponding embodiment of a strip of nails 15 according to the invention with a number of attachment means 1 according to the invention connected to one another by separable bars 16 is produced from steel.

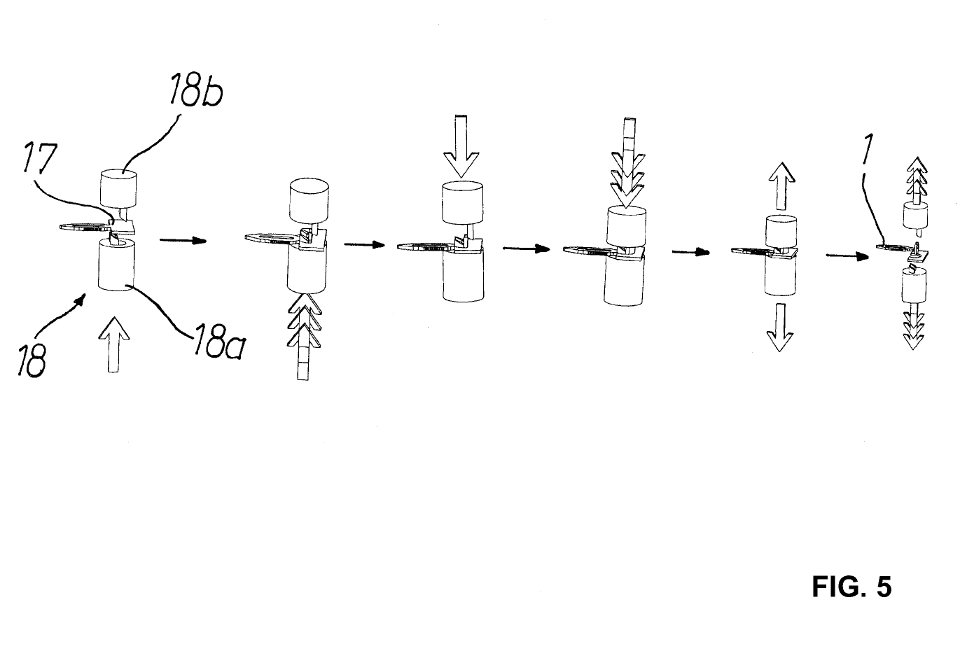

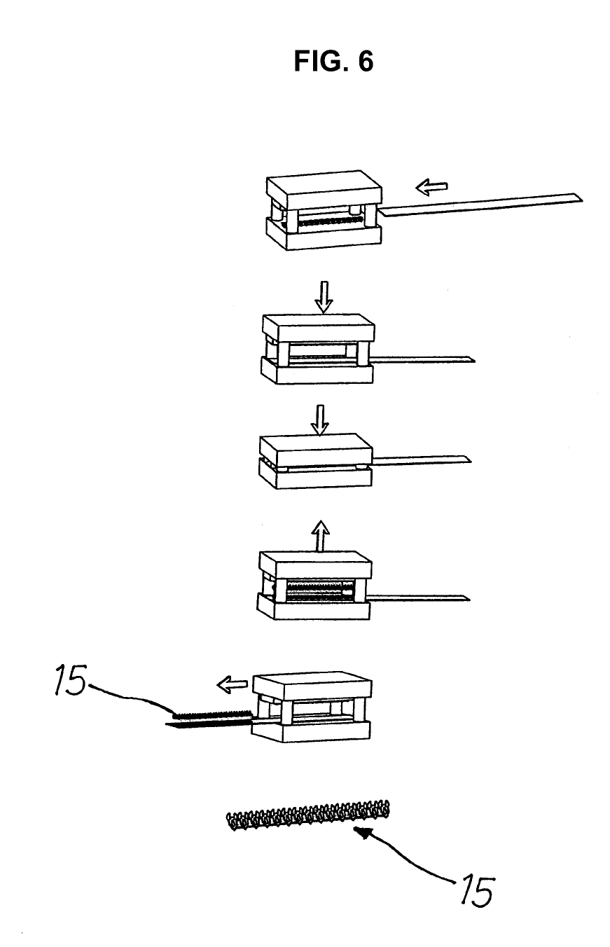

In FIG. 5, the production, in principle, of an attachment means 1 according to the invention is shown diagrammatically. First of all a blank 17 is inserted into a punching/bending apparatus 18 made up from two tool halves 18a, 18b. The blank 17 is punched out here so that the outer contour of the attachment means 1 is already totally provided in the region of the shaft 2. Only the head region 4 is not yet finally formed. The blank 17 was punched from a metal sheet. In order to now produce a head 4 disposed centrically above the shaft 2, a lower tool 18a initially moves towards the head region of the blank 17 and punches out a first half of the head 4. With the downwards movement of the lower part of the tool 18a the cuts 7 are made in the head 4 and at the same time the sections 5 of the head 4 are bent such that the sections 5 of the head 4 extend substantially perpendicularly to the shaft 2.

In the next step an upper part of the tool 18b is set in motion and punches out the second half of the head 4 in the downwards movement and likewise simultaneously bends the latter downwards.

Finally, the tool halves 18a, 18b move apart from one another again so that completed attachment means 1 can be ejected from the punching/bending apparatus 18.

The finished attachment element 1 has sections 5 of the head 4 which project over the shaft 2 to both sides of a bend line 6 formed between the end regions of the cuts 7 upon bending the head 4 as well as transversely to the latter. After bending, the head 4 is disposed as desired centrically to the shaft 2. For this purpose the cuts 7 are made parallel to the side surfaces of the shaft 2 in the region of the head 4 and extend here from the outer limit of the head 4 to a central line formed by this two-dimensional extension of the shaft 2.

Finally, FIG. 6 shows a strip of nails 15 produced in a one-step method with a number of attachment means 1 according to the invention connected to one another by a number of bars 16 and held in position, and which is suitable for use in a nail placement machine.

In order to produce the strip of nails, a metal strip 19 is first of all introduced into the punching/bending apparatus 18. Then the upper tool is moved towards the lower tool, by means of which the outer contours of a number of attachment means 1 and the bars 16 connecting the attachment means 1 are punched and cut out from the metal sheet 19. At the same time cuts 7 are made in the respective attachment means 1, in particular over the extension of the outer contours of the respective shafts 2 into the attachment means 1. While making the cuts 7 the heads 4 are simultaneously bent such that they extend substantially perpendicularly to the shafts 2. The heads 4 are arranged such that the sections 5 of the latter respectively project over the shafts 2 to both sides of the bend line 6 formed upon bending the heads 4 between the end regions of the cuts 7 as well as transversely to the latter.

Finally, the upper tool is raised again so that the completed strip of nails 15 made of steel can be ejected easily and is provided in a form which allows a use in a nail placement machine without any restrictions.

Alternatively, the punching/cutting process and the bending process can also take place consecutively in two procedural steps, or also in two apparatuses separate from one another.

Various features and advantages of the invention are set forth in the following claims.

What is claimed is:

1. An attachment means, in particular a nail for use in dry construction, which is made in one piece from a plane raw material by punching and/or cutting and bending, having a shaft on one end region of which a point and on the other end region of which a head bent substantially perpendicularly to the two-dimensional extension of the shaft are formed, wherein sections of the head project over the shaft to both sides of a bend line formed upon bending the head.

2. The attachment means according to claim 1, wherein the head is designed such that it projects over the shaft to both sides of the two-dimensional extension of the shaft as well as transversely to the latter.

3. The attachment means according to claim 1, wherein the head has a substantially circular cross-sectional surface which is disposed centrically to the shaft.

4. The attachment means according to claim 1, wherein cuts are provided on the head, in particular in the projection of the shaft, between the end regions of which the bend line extends.

5. The attachment means according to claim 4, wherein a notch is formed in the head the dimensions of which are defined by the bend line and the form of the cuts.

6. The attachment means according to claim 5, wherein the contour of the notch substantially corresponds to the outer contour of at least one section of the shaft in the region beneath the head.

7. The attachment means according to claim 1, wherein an end region of at least one section of the head has a further bend line about which the end region is bent relative to the head.

8. The attachment means according to claim 1, wherein the head is designed with a slant in order to avoid any damage to a component surface of a component facing towards the head and to be equipped with the attachment means.

9. A strip of nails for a nail placement appliance which is made in one piece from a plane raw material by punching and/or cutting and bending from a number of attachment means according to claim 1 connected to one another by means of at least one separable bar.

10. A method of producing an attachment means, in particular a nail according to claim 1, having a shaft on one end region of which a point and on the other end region of which a head bent substantially perpendicularly to the two-dimensional extension of the shaft are formed, the attachment means being formed in one piece from a plane raw material,
an outer contour of the attachment means being punched/cut out from the plane raw material;
cuts being made in the attachment means, in particular in the extension of the outer contour of the shaft;
the attachment means being bent in the region of the cuts after or while making the cuts such that the head extends substantially perpendicularly to the shaft, sections of the head projecting over the shaft to both sides of a bend line formed upon bending the head between end regions of the cuts.

11. The method according to claim 10, wherein the cuts are made so that the head extends centrically to the shaft after bending.

12. A method of producing a strip of nails, in particular for dry construction, from a number of attachment means, in particular according to claim 1, which respectively have a shaft on one end region of which a point and on the other end region of which a head bent substantially perpendicularly to the plane extension of the shaft are formed, and connected to one another by means of at least one attachment bar, the strip of nails being formed in one piece from a plane raw material,
an outer contour of the attachment means connected to one another by means of the bars being punched/cut out from the plane raw material;
cuts being made in the attachment means, in particular in the extension of the outer contour of the respective shafts;
the attachment means being bent in the region of the cuts after or while making the cuts such that the heads respectively extend substantially perpendicularly to the shafts, sections of the heads respectively projecting over the shafts to both sides of a bend line formed between the end regions of the cuts upon bending the heads.

13. The method according to claim 12, wherein the cuts are made such that the heads respectively extend centrically to the shafts after bending.
